(19) United States
(12) Patent Application Publication
(10) Pub. No.: US 2022/0105525 A1
(43) Pub. Date: Apr. 7, 2022

(54) FAN JET NOZZLE ASSEMBLY

(71) Applicants: Perry M. Hanchey, JR., McCleary, WA (US); Tyrel J. Rothell, McCleary, WA (US); Brandon R. Montesano, McCleary, WA (US)

(72) Inventors: Perry M. Hanchey, JR., McCleary, WA (US); Tyrel J. Rothell, McCleary, WA (US); Brandon R. Montesano, McCleary, WA (US)

(73) Assignee: Diamond Technology Innovations, Olympia, WA (US)

(21) Appl. No.: 17/062,320

(22) Filed: Oct. 2, 2020

(51) Int. Cl. B05B 1/04; B08B 3/02; B24C 5/04

(52) U.S. Cl. CPC B05B 1/04; B24C 5/04; B08B 3/02

(57) ABSTRACT

A nozzle assembly that includes a nozzle mount with a first end having a first opening and a second end having a second opening. The nozzle mount has a bore therein that extends from the first opening to the second opening. A diamond orifice is configured to fit within the bore. The diamond orifice is held in place by a retainer within the bore of the nozzle mount. The diamond orifice has a non-circular opening and is positioned within the bore such that a fluid entering the first end of the nozzle mount exits the second end of the nozzle mount through the non-circular opening of the diamond orifice.

### FIELD OF THE INVENTION

This invention generally relates to a nozzle assembly for a fan jet.

### BACKGROUND OF THE INVENTION

Systems using jets of fluid, such as water, abrasive-laden water, or other similar liquids have been used in industry for various purposes, such as cutting or surface cleaning different types of materials. Pure water may be sufficient if the materials to be cut or cleaned are relatively soft or thin. However, for certain materials and/or applications, it is advantageous for the fluid to be mixed with an abrasive material so as to obtain better cleaning characteristics or a more powerful jet. Generally, the systems create a high-pressure jet of water or a liquid by directing the pressurized fluid to a jet-forming nozzle which is housed in an outlet of the assembly.

Systems created specifically for surface cleaning are often designed to generate a laminar jet, spray jet, or fan jet fluid flow in which a column of compressed fluid is accelerated through a small opening to generate a high velocity stream of fluid that is either a laminar column, or one that spreads out at an angle after exiting the small opening. These various patterned jet streams are used based on the performance characteristics of each in the application they are performing in. A fan-shaped jet of high-velocity fluid typically has enough energy to efficiently remove layers of material (e.g., paints and other surface coatings, tar, concrete, dirt, grime, particle contaminants, etc.) from existing surfaces.

In a conventional fan-jet system such as illustrated in FIG. 1, the jet-forming nozzle 100 is manufactured by machining out a bore 102 from a blank of tungsten carbide, ceramic, or annealed stainless steel. The bore 102 is made at a first end 104 of the jet-forming nozzle 100 and extends almost to a second and opposite end 106 of the jet-forming nozzle 100. Typically, the bore 102 has a semi-spherical end 112 inside of the nozzle 100 near the second end 106. The internal surface along the nozzle bore 102 may be finished by pressing a die into the bore 102, thereby eliminating machining marks and improving the internal surface quality. A notch 108 is then machined out of the second end 106 of the nozzle 100 to a sufficient depth such that a shape of the exit orifice 110 is defined by the intersection of the bore 102 and the notch 108.

In these conventional systems, due to the high pressures at which fluid is forced out of the exit orifice 110, over time the size and shape of the exit orifice 110 changes growing larger, thus reducing the pressure of the fluid out of the exit orifice 110. This problem is compounded when the fluid contains abrasives, contaminants, or debris as these may severely shorten the useful life of the jet-forming nozzle 100.

Embodiments of the present invention address some of the aforementioned problems affecting conventional fluid jet systems, and represent an improvement over the state of the art. These and other advantages of the invention, as well as additional inventive features, will be apparent from the description of the invention provided herein.

### BRIEF SUMMARY OF THE INVENTION

In one aspect, embodiments of the invention provide a nozzle assembly that includes a nozzle mount with a first end having a first opening and a second end having a second opening. The nozzle mount has a bore therein that extends from the first opening to the second opening. A diamond orifice is configured to fit within the bore. The diamond orifice can be held in place by a retainer within the bore of the nozzle mount, or retained therein by other means of retention. The diamond orifice has a non-circular opening and is positioned within the bore such that a fluid entering the first end of the nozzle mount exits the second end of the nozzle mount through the non-circular opening of the diamond orifice. In the context of this invention, the term “orifice” is used to represent a body having an exit opening for the fluid jet discharged from the nozzle assembly.

In a particular embodiment, when a pressurized stream of fluid flows through the nozzle assembly, the non-circular opening is configured to produce a fan-shaped stream of fluid with a fan angle ranging from 10 degrees to 90 degrees. In a more particular embodiment, when a pressurized stream of fluid flows through the nozzle assembly, the non-circular opening is configured to produce a fan-shaped stream of fluid with a fan angle ranging from 12 degrees to 18 degrees. The non-circular opening may be configured such that the fan-shaped stream of fluid exits the non-circular opening with equal force across an entire profile of the fan-shaped stream.

In certain embodiments, the nozzle mount and diamond orifice are configured to accommodate a constant fluid flow at a pressure of at least 60,000 psi for at least 100 hours. In other embodiments, the nozzle mount and diamond orifice are configured to accommodate a constant fluid flow at a pressure of at least 94,000 psi for at least 20 hours. In some embodiments, the nozzle mount and diamond orifice are configured to accommodate a constant fluid flow at a pressure of at least 20,000 psi for at least 200 hours. In specific embodiments, for either of the two foregoing situations, after the constant fluid flow at a pressure of at least 60,000 psi for at least 100 hours, or after the constant fluid flow at a pressure of at least 94,000 psi for at least 20 hours, there is no measurable change in the size or shape of the non-circular opening. Due to the material hardness and inherent strength characteristics of the diamond orifice, the non-circular opening resists wear, degradation, or enlargement even after prolonged use at extremely high pressures.

Furthermore, the diamond orifice may be disk-shaped and disposed within a circular bore. Also, in some embodiments, the diamond orifice is positioned closer to the second opening than to the first opening, and wherein the first opening is larger than the second opening. The diamond orifice may be made from one of polycrystalline diamond, natural single crystal diamond, and chemical vapor deposition (CVD) monocrystalline diamond.

In another aspect, embodiments of the invention provide a nozzle assembly that includes a nozzle mount with a first end having a first opening and a second end having a second opening. The nozzle mount has a bore therein that extends from the first opening to the second opening. An orifice, made from a material with a greater than 9.0 hardness on the Mohs hardness scale, is configured to fit within the bore. The orifice is retained in place within the bore of the nozzle mount. The orifice has a non-circular opening and is positioned within the bore such that a fluid entering the first end of the nozzle mount exits the second end of the nozzle mount through the non-circular opening of the orifice.

In a particular embodiment, when a pressurized stream of fluid flows through the nozzle assembly, the non-circular opening in the orifice is configured to produce a fan-shaped stream of fluid with a fan angle ranging from 10 degrees to 90 degrees. In a more particular embodiment, when a pressurized stream of fluid flows through the nozzle assembly, the non-circular opening is configured to produce a fan-shaped stream of fluid with a fan angle ranging from 12 degrees to 18 degrees. The non-circular opening may be configured such that the fan-shaped stream of fluid exits the non-circular opening with equal force across an entire profile of the fan-shaped stream.

In certain embodiments, the nozzle mount and orifice are configured to accommodate a constant fluid flow at a pressure of at least 60,000 psi for at least 100 hours. In other embodiments, the nozzle mount and orifice are configured to accommodate a constant fluid flow at a pressure of at least 94,000 psi for at least 20 hours. In some embodiments, the nozzle mount and diamond orifice are configured to accommodate a constant fluid flow at a pressure of at least 20,000 psi for at least 200 hours. In specific embodiments, for either of the two foregoing situations, after the constant fluid flow at a pressure of at least 60,000 psi for at least 100 hours, or after the constant fluid flow at a pressure of at least 94,000 psi for at least 20 hours, there is no measurable change in the size or shape of the non-circular opening. Due to the material hardness and inherent strength characteristics of the orifice, the non-circular opening resists wear, degradation, or enlargement even after prolonged use at extremely high pressures.

Additionally, the aforementioned orifice may be disk-shaped and disposed within a circular bore. Also, in some embodiments, the orifice is positioned closer to the second opening than to the first opening, and wherein the first opening is larger than the second opening.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIGS. 1A and 1B are cross-sectional and end views, respectively of a prior art machined fan jet;

FIG. 2A is a perspective view of a nozzle for a “straight” jet fluid system;

FIG. 2B is a perspective view of a nozzle for a fan jet fluid system, in accordance with an embodiment of the invention;

FIGS. 3A and 3B are a cross-sectional views of a nozzle assembly, constructed in accordance with an embodiment of the invention; and

FIGS. 4A-4F are each end views showing various possible shapes for the exit opening of the nozzle assembly, in accordance with an embodiment of the invention.

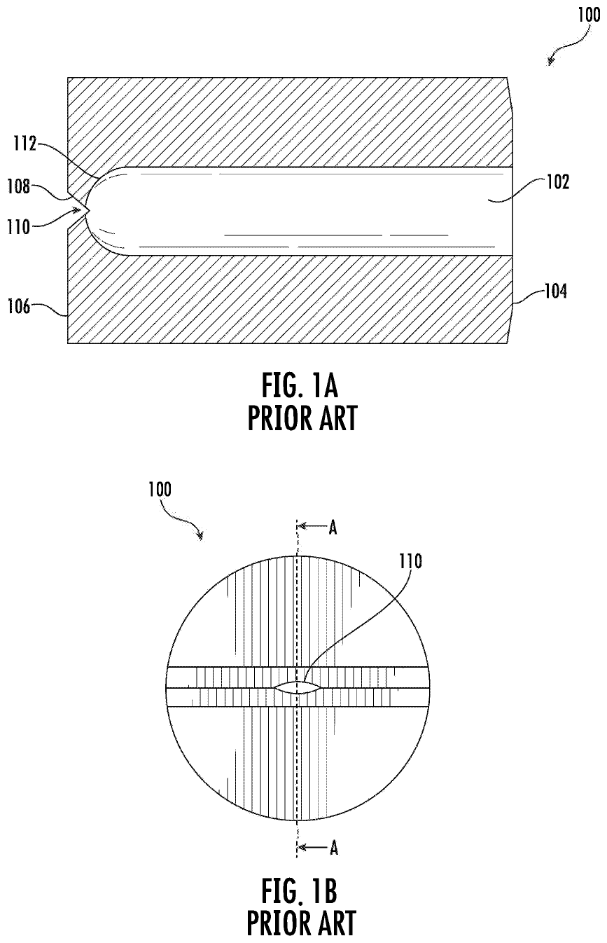

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Embodiments of the invention to be described herein include a fan jet nozzle assembly having a diamond orifice to provide the fan-shaped jet of fluid. The diamond orifice is machined to include an exit opening through which the jet of fluid exits the nozzle assembly. As will be explained below, the exit opening to create the fan-shaped jet of fluid is non-circular and typically elongated more along a first axis than a second orthogonal axis. While examples of the types of elongated openings that might be used in the orifice of the present invention, one of ordinary skill will recognize that a large number of elongated shapes may be suitable for the exit opening. However, one of ordinary skill would also recognize that diamond and materials of similar hardness are extremely difficult to machine and process with precision. Consequently, industry-standard nozzles are typically made with much simpler-to-machine materials such as steel, ceramic, carbide, etc.

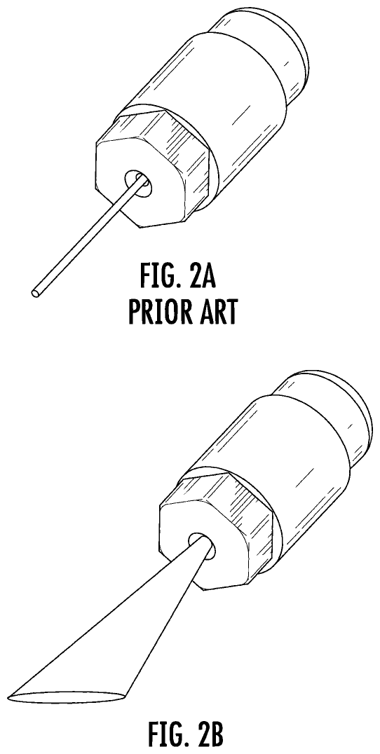

More specifically, diamond and similarly hard material are extremely difficult to machine to provide openings having complex shapes. For that reason, when diamond, or a similarly hard material, is used in fluid jet systems, users typically drill or lase holes or cone shapes (i.e., nothing more complex than a circle) into the diamond to form “straight” fluid jet nozzles, such as shown in FIG. 2A, where the fluid jet from such a device as a concentric or circular column of fluid. However, as will be explained below, embodiments of the invention include systems that use a diamond orifice to produce a fan-shaped fluid jet, such as shown in FIG. 2B. It should be noted that the scope of the invention described herein include those systems which have an orifice made from materials, either natural or synthetic, of sufficient hardness where the material hardness may be similar to that of diamond.

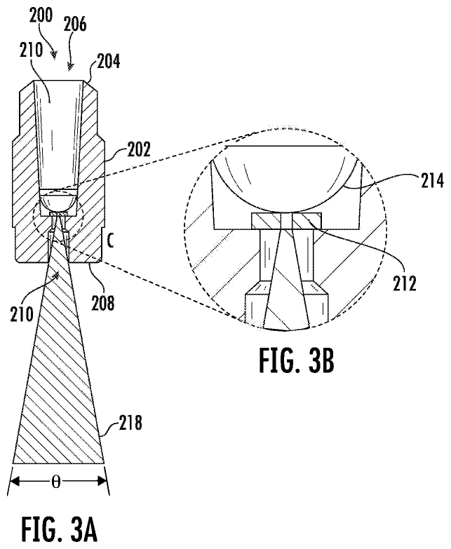

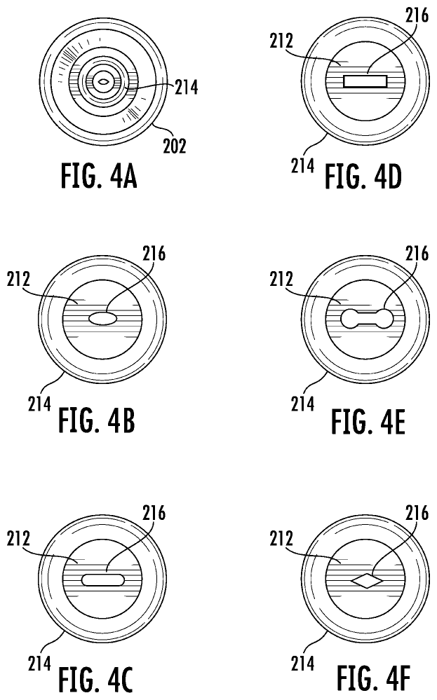

FIGS. 3A and 3B are cross-sectional views of a nozzle assembly 200 for a fan jet fluid flow system, according to an embodiment of the invention. The nozzle assembly 200 includes a nozzle mount 202 with a first end 204 having a first opening 206 and a second end 208 having a second opening 210. The nozzle mount 202 has a bore 210 therein that extends from the first opening 204 to the second opening 206. A diamond orifice 212 is configured to fit within the bore 210. The diamond orifice 212 may held in place by a retainer 214 within the bore 210 of the nozzle mount 202, or retained therein by other means of retention. In certain embodiments, the diamond orifice 212 has a non-circular opening 216 (shown in FIGS. 4A-4F) and is positioned within the bore 210 such that a fluid entering the first end 201 of the nozzle mount 202 exits the second end 206 of the nozzle mount 202 through the non-circular opening 216 of the diamond orifice 212. As can be seen from FIGS. 4A-4F, the non-circular opening 216 can take several possible shapes, including, but not limited to, elliptical, oval, rectangular, rhomboid, barbell-shaped, etc.

In alternate embodiments of the nozzle assembly 200, the orifice 212 is made from a material having a hardness similar or equal to that of diamond, and is machined to have the same non-circular opening 216 described above. Further, as in the embodiment described above, the orifice 212 is positioned within the bore 210 such that a fluid entering the first end 201 of the nozzle mount 202 exits the second end 206 of the nozzle mount 202 through the non-circular opening 216 of the diamond orifice 212.

The diamond orifice 212 may be disk-shaped and disposed within a circular bore 210 of the nozzle mount 202. Also, in some embodiments such as FIG. 3A, the diamond orifice 212 is positioned closer to the second opening 210 than to the first opening 206. As also shown in FIG. 3A, the first opening 206 may be larger than the second opening 210. Furthermore, the diamond orifice 212 may be made from one of polycrystalline diamond, natural single crystal diamond, and CVD monocrystalline diamond or other materials of similar hardness, i.e., a material having greater than 9.0 hardness on the Mohs hardness scale.

One of the advantages to using a diamond orifice 212 (or a material of similar hardness) is that diamond material does not degrade or deteriorate as high pressure fluids pass through it, so the non-circular opening 216 exhibits no change in size or shape over time. This allows for a very consistent flow rate and fan angle during their use of the nozzle assembly 200. Additionally, it is noted that the design for the nozzle assembly 200 of the present invention is readily adaptable and can be integrated into a variety of system designs.

This represents a significant improvement over conventional systems which, due to the difficulty in achieving precisely-toleranced non-circular openings in very hard materials, typically use metal, carbide, or ceramic nozzles. However, these conventional materials, in all cases over hours of use at high pressures, will have the exit openings of the fluid jet erode causing the exit openings to become larger inside as the material degrades or deteriorates, which makes the volume of fluid flow increase, and makes the fluid jet pressure decrease. Additionally, this degradation or deterioration of the material around the exit opening often changes the shape of the opening so that the fan angle and fan shape change over time. As a result of the orifice material, standard nozzles made with steel, ceramic, carbides, etc., can generally only accommodate flow pressures ranging from 10,000 psi to a maximum of 20,000 psi, and usually for no more than 20 hours and often for far less than 20 hours. Moreover, the change in shape to the exit opening over time results in a fluid jet profile in which the force is inconsistent, being stronger or weaker in some portions of the fluid jet profile than in others. The result is a fluid jet that does not clean or remove surface materials consistently or efficiently.

By contrast, the diamond orifice 212 of the present invention is designed to operate with constant flow pressures of at least 60,000 psi, and configured to perform at constant flow pressures at or greater than 94,000 psi. Further, the diamond orifice 212 is configured to operate at this pressure (94,000 psi) for hundreds of hours with no measurable change in the size or shape of the non-circular opening 216. In some embodiments, the nozzle mount 202 and diamond orifice 212 (or an orifice of similar hardness) are configured to accommodate a constant fluid flow at a pressure of at least 20,000 psi for at least 200 hours.

In a specific embodiment, the nozzle mount 202 and orifice or diamond orifice 212 are configured to accommodate a constant fluid flow at a pressure of at least 60,000 psi for at least 100 hours. In other embodiments, the nozzle mount 202 and orifice or diamond orifice 212 are configured to accommodate a constant fluid flow at a pressure of at least 94,000 psi for at least 20 hours.

In specific embodiments, for either of the two foregoing situations, after the constant fluid flow at a pressure of at least 60,000 psi for at least 100 hours, or after the constant fluid flow at a pressure of at least 94,000 psi for at least 20 hours, there is no measurable change in the size or shape of the non-circular opening 216.

In a further embodiment, an orifice 212 made of materials similarly hard as diamond is configured to operate at the pressures and for the time periods described above, and with the same lack of degradation in the size and shape of the exit opening 216. Due to the material hardness and inherent strength characteristics of the diamond orifice 212, the non-circular opening 216 resists wear, degradation, or enlargement even after prolonged use at extremely high pressures.

As can be seen in the multiple end views of FIGS. 4A-4F, the non-circular opening 216 is configured such that a pressurized stream of fluid flowing through the nozzle assembly 200 produces a fan-shaped stream of fluid 218 with a fan angle (shown by θ) ranging from 10 degrees to 90 degrees. In a more particular embodiment, the non-circular opening 216 is configured to produce a fan-shaped stream of fluid with a fan angle ranging from 12 degrees to 18 degrees when a pressurized stream of fluid flows through the nozzle assembly 200.

The diamond orifice 212 is designed to produce a “flat” jet stream profile, the energy stays uniformly disbursed across the fan. These diamond orifice 212 has internal features with highly exacting tolerances and surface finishes which need to be maintained in order to produce a uniform fan-shaped jet stream. Microscopic flaws on the internal edges of the diamond orifice 212 could disrupt the uniformity of the fan jet stream. However, when the diamond orifice 212 is machined as intended, the non-circular opening 216 is configured such that the fan-shaped stream of fluid exits the non-circular opening 216 with an equal force across the entire profile of the fan-shaped stream.

The diamond orifice 212 and non-circular opening 216 are configured to produce a uniformly consistent fan-shaped spray pattern that offers an equal energy focus across the entire fan-shaped profile, which provides a consistent force or pressure from the fluid jet at all points where the fluid contacts the work piece. The fan jet nozzle's equal distribution of fluid energy allows for the assembly 200 to be used in a way that control the depths of cuts or material removal evenly and predictably. As such, the nozzle assembly 200 described herein allows for the removal of a layer of material from an underlying surface without damaging the underlying surface (e.g., removing a paint layer from a road surface without damaging the asphalt).

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A nozzle assembly comprising:
a nozzle mount with a first end having a first opening and a second end having a second opening, the nozzle mount having a bore therein that extends from the first opening to the second opening; and
a diamond orifice configured to fit within the bore, the diamond orifice being retained within the bore of the nozzle mount, the diamond orifice having a non-circular opening and positioned within the bore such that a fluid entering the first end of the nozzle mount exits the second end of the nozzle mount through the non-circular opening of the diamond orifice.

2. The nozzle assembly of claim 1, wherein, when a pressurized stream of fluid flows through the nozzle assembly, the non-circular opening is configured to produce a fan-shaped stream of fluid with a fan angle ranging from 10 degrees to 90 degrees.

3. The nozzle assembly of claim 2, wherein, when a pressurized stream of fluid flows through the nozzle assembly, the non-circular opening is configured to produce a fan-shaped stream of fluid with a fan angle ranging from 12 degrees to 18 degrees.

4. The nozzle assembly of claim 2, wherein the non-circular opening is configured such that the fan-shaped stream of fluid exits the non-circular opening with equal force across an entire profile of the fan-shaped stream.

5. The nozzle assembly of claim 1, wherein the nozzle mount and diamond orifice are configured to accommodate a constant fluid flow at a pressure of at least 20,000 psi for at least 200 hours.

6. The nozzle assembly of claim 1, wherein the nozzle mount and diamond orifice are configured to accommodate a constant fluid flow at a pressure of at least 60,000 psi for at least 100 hours.

7. The nozzle assembly of claim 1, wherein the nozzle mount and diamond orifice are configured to accommodate a constant fluid flow at a pressure of at least 94,000 psi for at least 20 hours.

8. The nozzle assembly of claim 7, wherein, after the constant fluid flow at a pressure of at least 94,000 psi for at least 20 hours, or at a pressure of at least 60,000 psi for at least 100 hours, there is no measurable change in the size of the non-circular opening.

9. The nozzle assembly of claim 1, wherein the diamond orifice is disk-shaped and disposed within a circular bore.

10. The nozzle assembly of claim 1, wherein the diamond orifice is positioned closer to the second opening than to the first opening, and wherein the first opening is larger than the second opening.

11. The nozzle assembly of claim 1, wherein the diamond orifice is made from one of polycrystalline diamond, natural single crystal diamond, and CVD monocrystalline diamond.

12. The nozzle assembly of claim 1, wherein a shape of the non-circular opening is one of elliptical, oval, rectangular, rhomboid, and barbell-shaped.

13. A nozzle assembly comprising:
a nozzle mount with a first end having a first opening and a second end having a second opening, the nozzle mount having a bore therein that extends from the first opening to the second opening; and
an orifice made from a material with a greater than 9.0 hardness on the Mohs hardness scale, the orifice configured to fit within the bore, the orifice being retained within the bore of the nozzle mount, the orifice having a non-circular opening and positioned within the bore such that a fluid entering the first end of the nozzle mount exits the second end of the nozzle mount through the non-circular opening of the orifice.

14. The nozzle assembly of claim 13, wherein, when a pressurized stream of fluid flows through the nozzle assembly, the non-circular opening is configured to produce a fan-shaped stream of fluid with a fan angle ranging from 10 degrees to 90 degrees.

15. The nozzle assembly of claim 14, wherein the non-circular opening is configured such that the fan-shaped stream of fluid exits the non-circular opening with equal force across an entire profile of the fan-shaped stream.

16. The nozzle assembly of claim 13, wherein, when a pressurized stream of fluid flows through the nozzle assembly, the non-circular opening is configured to produce a fan-shaped stream of fluid with a fan angle ranging from 12 degrees to 18 degrees.

17. The nozzle assembly of claim 13, wherein the nozzle mount and diamond orifice are configured to accommodate a constant fluid flow at a pressure of at least 20,000 psi for at least 200 hours.

18. The nozzle assembly of claim 13, wherein the nozzle mount and orifice are configured to accommodate a constant fluid flow at a pressure of at least 60,000 psi for at least 100 hours.

19. The nozzle assembly of claim 13, wherein the nozzle mount and orifice are configured to accommodate a constant fluid flow at a pressure of at least 94,000 psi for at least 20 hours.

20. The nozzle assembly of claim 19, wherein, after the constant fluid flow at a pressure of at least 94,000 psi for at least 20 hours, or at a pressure of at least 60,000 psi for at least 100 hours, there is no measurable change in the size of the non-circular opening.

21. The nozzle assembly of claim 13, wherein the orifice is disk-shaped and disposed within a circular bore.

22. The nozzle assembly of claim 13, wherein the orifice is positioned closer to the second opening than to the first opening, and wherein the first opening is larger than the second opening.

23. The nozzle assembly of claim 13, wherein a shape of the non-circular opening is one of elliptical, oval, rectangular, rhomboid, and barbell-shaped.

24. An orifice comprising:
a body made of diamond or from a material with a greater than 9.0 hardness on the Mohs hardness scale, the body having a non-circular opening machined therein, wherein, when a pressurized stream of fluid is forced through the non-circular opening, the non-circular opening is configured to produce a fan-shaped stream of fluid with a fan angle ranging from 10 degrees to 90 degrees.

25. The orifice of claim 24, wherein, when a pressurized stream of fluid is forced through the non-circular opening, the non-circular opening is configured to produce a fan-shaped stream of fluid with a fan angle ranging from 12 degrees to 18 degrees.

26. The orifice of claim 24, wherein, after a constant fluid flow through the non-circular opening at a pressure of at least 94,000 psi for at least 20 hours, or at a pressure of at least 60,000 psi for at least 100 hours, there is no measurable change in the size of the non-circular opening.

27. The orifice of claim 24, wherein the diamond orifice is made from one of polycrystalline diamond, natural single crystal diamond, and CVD monocrystalline diamond.

28. The orifice of claim 24, wherein a shape of the non-circular opening is one of elliptical, oval, rectangular, rhomboid, and barbell-shaped.

29. The orifice of claim 24, wherein the orifice is disk-shaped.
